(19) United States
(12) Patent Application Publication
(10) Pub. No.: US 2024/0422136 A1
(43) Pub. Date: Dec. 19, 2024

(54) DATA AGGREGATION IN FEDERATED COMPUTING

(71) Applicant: Apple Inc., Cupertino, CA (US)

(72) Inventors: Bernhard Raaf, Neuried (DE); Antonia Wachter-Zeh, Munich (DE); Christoph Hofmeister, Munich (DE); Maximilian Egger, Munich (DE); Rawad Bitar, Munich (DE); Robert Zaus, Munich (DE); Sabine Roessel, Munich (DE)

(21) Appl. No.: 18/744,319

(22) Filed: Jun. 14, 2024

Related U.S. Application Data
(63) Continuation-in-part of application No. 63/521,168, filed on Jun. 15, 2023.

(51) Int. Cl. H04L 9/40; G06N 20/00; H04L 1/00

(52) U.S. Cl. CPC H04L 63/0428; G06N 20/00; H04L 1/0033

(57) ABSTRACT

A method performed by a client device is provided. The method includes obtaining, by a client device, data for transmission to a network server. The method includes determining, by the client device, a plurality of intermediate network nodes for transmission of the data, wherein the plurality of the intermediate network nodes are communicatively coupled to the network server. The method includes encoding, by the client device, the data using an encoding scheme. The method includes transmitting, by the client device and according to a data transmission scheme, a plurality of instances of the encoded data to the plurality of intermediate network nodes for aggregation by the intermediate network nodes with data received from one or more other client devices. Also provided are methods performed by an intermediate network node and a network server. The methods can be performed by one or more processors of an apparatus.

### CROSS-REFERENCE TO RELATED APPLICATIONS

This application is a continuation-in-part application of U.S. Provisional Patent Application No. 63/521,168, filed on Jun. 15, 2023, the content of which is incorporated herein by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

Wireless communication networks can be used for federated computing, also known as collaborative or decentralized computing. In federated computing, multiple client devices, such as user equipments (UEs), separately take part in a computing task. The client devices each transmit data corresponding to this computing task to a centralized network server, e.g., via one or more intermediate network nodes (e.g., wireless base stations and/or access points); the network server can process the data obtained from the client devices.

### SUMMARY

In accordance with one aspect of the present disclosure, a method performed by a client device is provided. The method includes obtaining, by a client device, data for transmission to a network server. The method includes determining, by the client device, a plurality of intermediate network nodes for transmission of the data, wherein the plurality of the intermediate network nodes are communicatively coupled to the network server. The method includes encoding, by the client device, the data using an encoding scheme. The method includes transmitting, by the client device and according to a data transmission scheme, a plurality of instances of the encoded data to the plurality of intermediate network nodes for aggregation by the intermediate network nodes with data received from one or more other client devices.

In accordance with one aspect of the present disclosure, a method performed by an intermediate network node is provided. The method includes determining, by an intermediate network node that is communicatively coupled to a plurality of client devices and at least one of a network server or one or more other intermediate network nodes, a data transmission scheme including aggregation of data received by the intermediate network node from the plurality of client devices. The data transmission scheme is determined based on information received from at least one of the network server or the one or more other intermediate network nodes. The network server is configured to process the data from the plurality of client devices. The method includes indicating, by the intermediate network node, the data transmission scheme to the plurality of client devices. The method includes receiving, by the intermediate network node and from one or more client devices of the plurality of client devices, the data transmitted by the one or more client devices according to the data transmission scheme. The method includes aggregating, by the intermediate network node, the data received from the one or more client devices. The method includes transmitting, by the intermediate network node, the aggregated data to the network server.

In accordance with one aspect of the present disclosure, a method performed by a network server is provided. The method includes establishing, by a network server, a plurality of communication links with a plurality of intermediate network nodes to receive data from a plurality of client devices via the plurality of intermediate network nodes. The method includes determining, based on information received from the plurality of intermediate network nodes, a data transmission scheme for the plurality of client devices to transmit data to the plurality of intermediate network nodes. The data transmission scheme includes aggregating, by each of the plurality of intermediate network nodes, data received at the intermediate network node from one or more of the plurality of client devices. The method includes indicating the data transmission scheme to at least one of the plurality of client devices or the plurality of intermediate network nodes. The method includes receiving, from at least one intermediate network node of the plurality of intermediate network nodes, aggregated data received by the at least one intermediate network node from one or more of the plurality of client devices according to the data transmission scheme. The method includes processing, by the network server, the data received from the at least one intermediate network node of the plurality of intermediate network nodes.

In accordance with one aspect of the present disclosure, a method performed by a network entity that is communicatively coupled to a plurality of client devices and at least one of a network server or one or more intermediate network nodes is provided. The method includes determining, by the network entity, a data transmission scheme including aggregation of data received by the one or more intermediate network nodes from the plurality of client devices. The data transmission scheme is determined based on information received from at least one of the network server or the one or more intermediate network nodes. The network server is configured to process the data from the plurality of client devices. The method includes indicating, by the network entity, the data transmission scheme to the plurality of client devices.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIGS. 2A and 2B together illustrate another example wireless network, according to some implementations.

FIG. 2C illustrates a layered architecture of the wireless network in FIGS. 2A and 2B, according to some implementations.

FIG. 3 illustrates communication links between components of an example wireless network that performs data aggregation for federated computing, according to some implementations.

FIGS. 4A and 4B each illustrate an example data transmission scheme for federated computing, according to some implementations.

FIGS. 5A-5D illustrate flowcharts of example methods for data aggregation in federated computing, according to some implementations.

FIG. 6 illustrates an example UE, according to some implementations.

FIG. 7 illustrates an example access node, according to some implementations.

### DETAILED DESCRIPTION

Federated computing has many applications. As an example, a server can be configured to train a machine learning model using data (also referred to as datasets or training data for training the machine learning model) obtained from multiple client devices (e.g., UEs) in a wireless network. In such a scenario, the UEs transmit individual datasets to one or more intermediate network nodes, which can be access nodes such as cellular base stations or wireless access points. The intermediate network nodes (also referred to as network nodes) forward the UEs' datasets to the server over backhaul communication links between the intermediate network nodes and the server.

Data privacy is often an important consideration in federated computing. For example, in the machine learning model training example above, the training data can be private to each client device, and it may be desirable to maintain privacy while training the machine learning model. For privacy, data of individual client devices should not be made accessible to the server or the intermediate network nodes. In some cases, for privacy reasons, rather than sending raw data to the server, each client device computes stochastic gradient descent (SGD) iterations based on respective private data and transmits the calculated gradient values to the server via the intermediate network nodes. This way, the server and the network nodes do not have direct access to the private data. However, it may still be possible to infer, at the server, private information by analyzing the gradient values individually obtained by the client devices, which creates risk of privacy breach. To reduce such risk, the client devices can encode the private data before transmission. Additionally, as described in greater detail by the implementations below, the network nodes can be configured to aggregate the encoded data received from multiple client devices, and forward the aggregated data to the server. An example of aggregation is to compute an average (e.g., weighted average) or sum of data gradient values from multiple client devices. In such cases, the server is limited to use the aggregated data to perform SGD iterations and train the machine learning model, which prevents the server from accessing individual client data.

In addition to aggregation at the intermediate network nodes, additional measures are implemented as disclosed herein to mitigate the risk from collusion amongst the intermediate network nodes. A network node is colluding if it has knowledge of the data received by other, non-colluding network nodes (e.g., by learning about on the communication between the client devices and the network nodes). Information from non-colluding or victim devices or client devices can be obtained via collusion with other colluding network nodes. If two or more colluding network nodes share portions of data from a particular client device that each colluding network node is aware of (e.g., its own received data and data obtained from another colluding node), information about private data of the particular client device can be determined by the instances of data shared by the colluding network nodes exceeding a threshold, the probability of which increases as the number of colluding network nodes increases, which can defeat privacy.

To address the risk from colluding network nodes, the disclosed implementations adopt either or a combination of two approaches: 1) information-theoretic (IT) privacy; and 2) computational privacy. In the IT privacy approach, a client device encodes its data with random information. For example, the client device can generate some random data (e.g., a nonce) and mask a portion of the private data with the random data to conceal the content of the portion. The client device can generate multiple instances of encoded data, with each instance being a portion or a full copy of the data and encoded using different random data and/or adding multiple random data with different weights to the individual instances and/or applying the random data to different portions of the private data, and transmit the instances to multiple network nodes. With this approach, a greater number of network nodes would have to collude to determine private data from the encoded instances of the dataset of a client device. If the maximum number of colluding network nodes in a wireless network is known, the risk of privacy breach due to collusion is addressed by a client device by sending different instances of encoded data to a number of network nodes that is greater than the maximum number of colluding network nodes. For this, multiple transmissions from the client device to the selected number of network nodes is performed, which can increase the communication cost, such as use of processing resources by the client device, power consumption, or network load, or any combination of these.

In the computational privacy approach, a client device encodes its data using an encryption algorithm, e.g., based on an encryption key shared by a network node and the client device. The encryption key, which is kept secret from the other network nodes and client devices, can be used to mask the private data. As such, it would be difficult for colluding network nodes to decode the encoded data from the client device that is obtained by spying, in the absence of the encryption key. Compared to the IT privacy approach, the computational privacy approach can be transmission cost-efficient because the client device does not need to transmit multiple instances of the encoded dataset. However, the computational privacy approach is less secure than the IT privacy approach in terms of data privacy, because it is theoretically possible to crack the encryption key (e.g., by brute force trial and error) and retrieve the private data if a network node has large enough computation power or novel developments in cryptanalysis are available. Moreover, the sharing of the encryption key (e.g., using a public key cryptographic mechanism) between the network node and the client device incurs additional communication between a client device and a network node prior to data transmission.

As described below, some implementations provide mechanisms that balance the need for data privacy and the availability of communication resources. In some cases, this is achieved by a hybrid approach that combines the IT privacy approach and the computational privacy approach. The disclosed implementations allow client devices (and/or network nodes, or network server, or any combination of these) in a wireless network to take into account competing factors and provide a suitable data transmission scheme for federated computing, which mitigates the cost of information transmission in a wireless network while maintaining target privacy levels, and increases the robustness and flexibility of the wireless network.

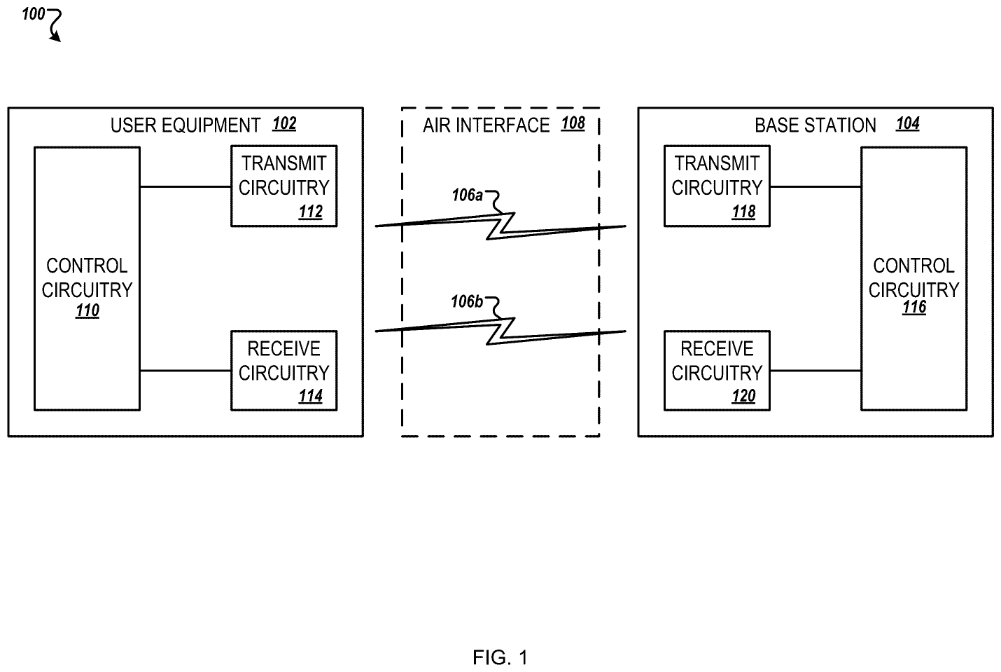

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For example, the control circuitry 110 can encode the data to be transmitted according to a data transmission scheme.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

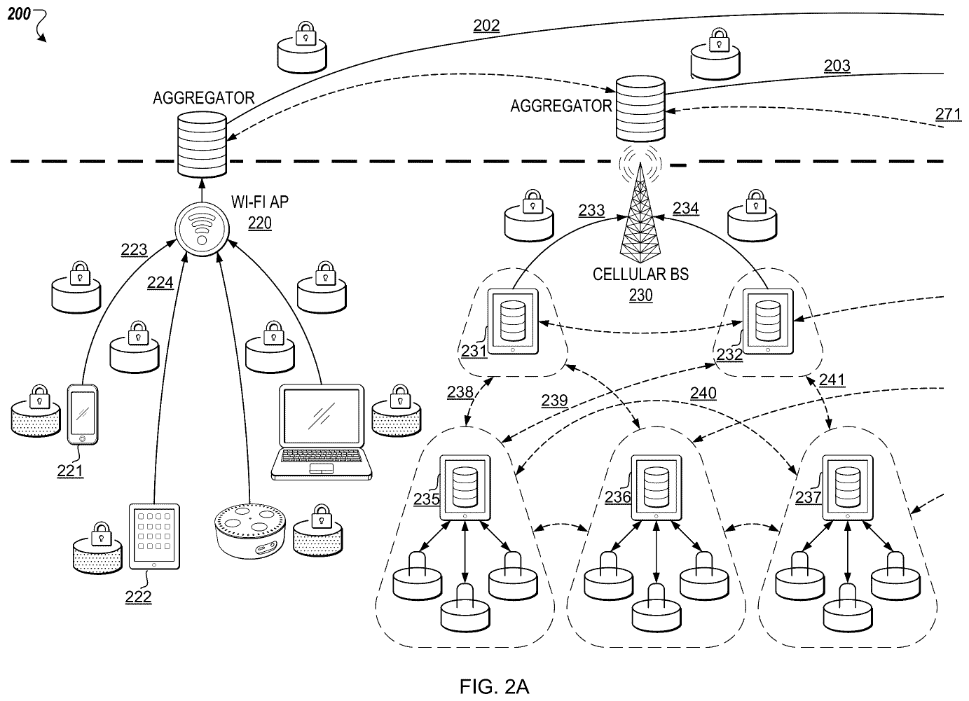

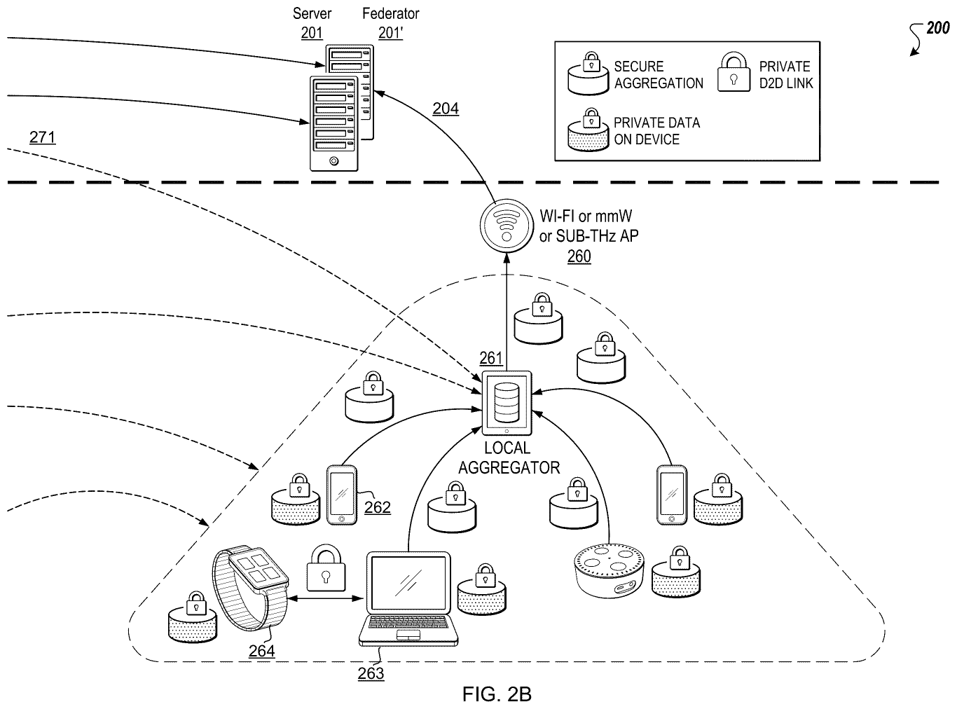

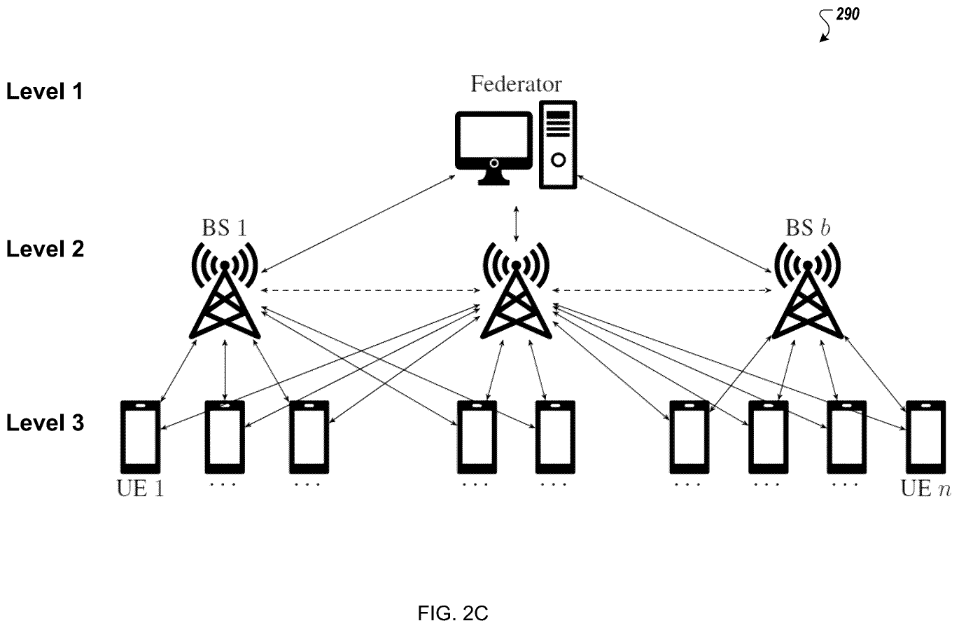

FIGS. 2A and 2B together illustrate another example wireless network 200, according to some implementations. Wireless network 200 has server 201 in communication with Wi-Fi access point (AP) 220 via communication link 202, with cellular base station (BS) 230 via communication link 203, and with Wi-Fi or millimeter-wave (mmWave) or sub-terahertz (THz) AP 260 via communication link 204. Communication links 202-204 can be backhaul links or core network links. AP 220, BS 230, and AP 260 each include, or are each coupled with, an aggregator, which can be software code and/or hardware circuit that has the capability of aggregating data instances received from different sources. In some implementations, the aggregators of AP 220, BS 230, and AP 260 are communicatively coupled to each other. AP 220, BS 230, and AP 260 can serve as intermediate network nodes that forward data received from downstream client devices to the server 201, while server 201 can serve as a federator in wireless network 200. In some implementations, server 201 can be coupled to a standalone federator 201′, which can determine a data transmission scheme and/or an encoding scheme, as described below. When determining the data transmission scheme and/or the encoding scheme, federator 201′ can provide the determined scheme(s) to the network components that participate in the federated computing (e.g., AP 220, BS 230, AP 260, and the downstream client devices).

Each of these intermediate network nodes is communicatively coupled to multiple client devices. For example, AP 220 is communicatively coupled to UEs 221 and 222 (which can be mobile terminals, tablets, personal computers, wearable devices, or other types of client devices), among others, via communication links 223 and 224, respectively. UE 221 can transmit private data to AP 220 via communication link 223 and UE 222 can transmit private data to AP 220 via communication link 224. AP 220, serving as an intermediate network node, can use its aggregator to aggregate the private data of UEs 221 and 222 and send the aggregated data of the plurality of UEs to the server. Additionally or alternatively, AP 220 can forward the received private data of individual client devices to server 201. In this context, private data sent by a UE includes client data that is manipulated (e.g., encoded) by the UE for privacy to prevent the intermediate network node from determining the data content. As described earlier and throughout this specification, the data is made private by applying either IT privacy to the data (e.g., adding randomly generated information to the data) or computational privacy to the data (e.g., encrypting the data using a cryptographic encryption mechanism).

Returning to FIGS. 2A-2B, BS 230 is communicatively coupled to UEs 231 and 232 via communication links 233 and 234, respectively. UE 231 can transmit private data to BS 230 via communication link 233 and UE 232 can transmit private data to BS 230 via communication link 234. BS 230, serving as an intermediate network node, can use its aggregator to aggregate the private data received from UEs 231 and 232 and send the aggregated data of the plurality of UEs to the server. Additionally or alternatively, BS 230 can forward received private data of individual client devices to server 201. UEs 231 and 232 each can also serve as an intermediate network node for respective downstream client devices, such as UEs 235-237, which are communicatively coupled to UEs 231 and 232 via communication links 238-241. UEs 231 and 232 can either use their own aggregators, which can be built-in to the UEs or dedicated devices coupled to the UEs, to aggregate the private data received from UEs 235-237 or forward the received private data to BS 230 for aggregation by BS 230. Likewise, UEs 235-237 can further serve as intermediate network nodes with respect to other downstream client devices. As such, a multi-level hierarchical network architecture is formed with more than one level of intermediate network nodes. Each intermediate network node and its subordinate (downstream) UEs can be regarded as a sub-network. Consistent with this architecture, UE 261 serves as an intermediate network node with respect to UEs 262 and 263, while UE 263 serves as an intermediate network node for UE 264. In some implementations, the closer a node (intermediate network node or UE) to the server in the hierarchy, the more likely the node performs functions of an aggregator (e.g., receiving and aggregating private data from other nodes lower in the hierarchy). Conversely, the farther a node to the server in the hierarchy, the more likely the node performs functions of a UE (e.g., obtaining and transmitting private data to nodes higher in the hierarchy).

In the above-described architecture, two or more intermediate network nodes at the same peer level may potentially collude by sharing private data that is known to respective intermediate network node with other colluding node(s). An intermediate network node may acquire knowledge of the private data either directly from one or more UEs or by eavesdropping on the communications from the UE(s) to other non-colluding intermediate network nodes. The collusion can be within the same sub-network (e.g., UEs 231 and 232) or across multiple sub-networks (e.g., via communication link 271 between BS 230 and UE 261). Additionally, even if a UE is not directly in communication with an intermediate network node, the UE can establish a device-to-device (D2D) communication link with another UE that is communicatively coupled to that intermediate network node. For example, UE 264 can establish a D2D communication link with UE 263 such that UE 264 can have its private date forwarded by UE 263 to the corresponding intermediate network node (UE 261 in this case).

FIG. 2C illustrates a layered architecture 290 corresponding to the wireless network 200 of FIGS. 2A and 2B, according to some implementations.

According to architecture 290, UEs 1 to n are considered to be at level 3 of a hierarchy. These UEs, or more generally, client devices (“clients”), are communicatively coupled to a federator and to each other via base stations 1 to b. Base stations (BS) 1 to b are considered to be at level 2 of the hierarchy, which is different from the level 3 of UEs 1 to n. The federator is at level 1 of the hierarchy, different from the level 3 of UEs 1 to n and the level 2 of BSs 1 to b. User data are transmitted from level 3 to level 2, and then to level 1 for federated computing.

In some situations, some BSs may collude (e.g., share private user data received from one or more UEs of level 3 without permission) among themselves or with the federator in an attempt to breach user data. In this disclosure, Z_{BS} denotes the maximum number of BSs that could possibly collude among themselves or with the federator. Also, some UEs may be part of the collusion of the colluding BSs. In this disclosure, Z_{UE} denotes the maximum number of UEs that could possibly join the collusion of the colluding BSs. The below description assumes each UE is communicatively coupled to at least (Z_{BS}+1) BSs.

In some implementations, architecture 290 can have more levels, such as one or more levels of relay devices between level 1 and level 2. Each of the relay devices can be implemented as a BS, a UE, or other types of network devices. Collusion can happen within the same level and across different levels.

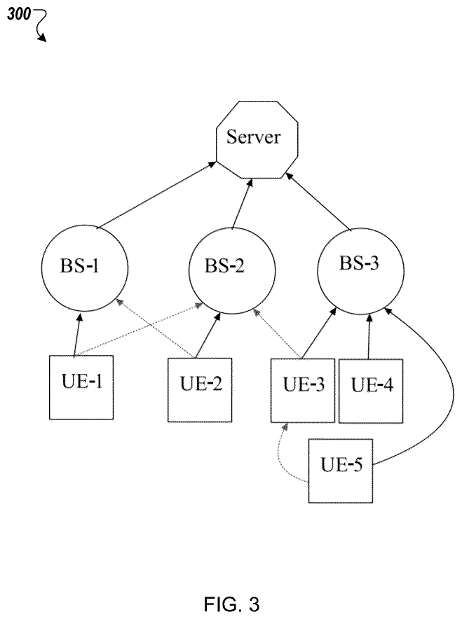

FIG. 3 illustrates communication links between components of an example wireless network 300 that performs data aggregation for federated computing, according to some implementations. In some implementations, wireless network 300 represents a simplified schematic of a network architecture that is similar to the wireless network 200 described with reference to FIGS. 2A and 2B.

As shown in FIG. 3, wireless network 300 has a server at the top of the hierarchy, communicatively coupled to three base stations: BS1, BS2, and BS3. Wireless network 300 also has five UEs: UE-1 to UE-5. UE-1 and UE-2 each have two communication links used to transmit data, including private data to the server via BS-1 or BS-2. UE-3 has two communication links used to transmit data, including private data, to the server via BS-2 or BS-3. UE-4 has one communication link to transmit private data to the server via BS-3. UE-5 has one communication link to transmit private data to the server via BS-3. Additionally or alternatively, UE-5 can transmit private data to the server via a communication path that includes a link from UE-5 to UE-3 and a link from UE-3 to BS-2. As such, each of UE-1, UE-2, UE-3, and UE-5 has a plurality (e.g., two as shown in FIG. 3) of independent (e.g., without overlapping) paths to provide private data to the server for federated computing.

To protect data privacy where collusion may exist between intermediate network nodes, the number of communication paths for transmitting a UE's private data to the server needs to be decided. In an ideal case where there are unlimited communication resources, a UE can adopt the IT privacy approach by making N instances of the private data, encoded using an encoding scheme. The UE can then transmit the N instances to N intermediate network nodes (where N is a positive integer). When the number of intermediate network nodes that collude is at most T (where T is a positive integer), N is increased to prevent the colluders from determining the private data contents of any UE, even when each colluder shares with other colluders private data of the UE that is known to the respective colluder, which can include private data directly received by the colluder from the UE, and/or private data the UE sends to other intermediate network nodes and which the colluder learns by eavesdropping on the communication links. This protection can be achieved by adding T random data instances into the encoding and encoding the private data instances, e.g., using different weights of the T random data instances. However further encoding schemes may also apply, e.g., using polynomials with multiple random coefficients evaluated at proper evaluation points. Additionally, because wireless transmissions may sometimes experience packet loss (“dropout”), N can further take into account a factor that indicates a maximum number of dropout instances of the encoded data. For example, assuming up to D instances may be lost during transmission, N can be increased such as D or more redundant instances are transmitted. That means even if D out of the N intermediate network nodes or the corresponding links to them from the UE or towards the server fail, the remaining N-D paths are sufficient to recover the desired information at the server. Considering both the collusion and the dropout risk, N generally takes a value that satisfies N>T+D.

Consistent with the above, in some implementations, the UE is configured, according to the data transmission scheme, to split the private data into K portions (where K is a positive integer) and create N=K+T+D instances of encoded data. The number of K can be determined as part of the data transmission scheme. For example, when the data transmission scheme provides that K=3, T=2, and D=1, the UE can split the private data A into K=3 portions, A₁, A₂, and A₃. The UE can also obtain T=2 instances of random data, R₁ and R₂. The UE can encode the combination of A₁, A₂, A₃, R₁, and R₂, e.g., using them as coefficients of a polynomial Ã=A₁+xA₂+x²A₃+x³R₁+x⁴R₂. Because N=K+T+D=6 in this example, the UE can create six instances of Ãᵢ using 6 different values of xᵢ (i=1, 2, . . . 6) and transmit the six instances of Ãᵢ to six intermediate network nodes.

Because T and D are typically given in a wireless network, the value of K can affect the number of transmission paths from the UE to the intermediate network nodes and consequently affect the communication resources utilized by the transmission. In addition, with T and D given, the value of K affects the efficiency of the data transmission scheme. For example, the amount of data transmitted per path can be inversely proportional to the value of K. A large value of K can increase the efficiency of the data transmission scheme but use more transmission paths and cost more resources. Accordingly, a tradeoff often needs to be made when the data transmission scheme is determined.

In some implementations, to reduce transmission cost and/or accommodate resources constraints in the computing capacities of the UEs and/or the intermediate network nodes, the IT privacy approach may be modified or replaced with the computational privacy approach. Furthermore, the communication cost and the communication/computing capacity may differ between communication links between UEs and intermediate network nodes and communication links between intermediate network nodes and the server. Thus, in some implementations, the wireless network decides whether the intermediate network nodes should aggregate the received data or transmit the received data to the server for aggregation. For these reasons, implementations disclose determination of a data transmission scheme for the UEs to encode and transmit the private data and for the intermediate network nodes to process the received data. The data transmission scheme includes determining how many intermediate network nodes a UE is to send its private data to, or what encoding scheme (e.g., IT privacy or computational privacy, or both) a UE is to use for each instance of sending private data to an intermediate network node, or a combination of both.

The determination can consider a variety of factors, such as the amount of data from the UEs, the UEs' and the intermediate network nodes' power for transmitting the data, the maximum number of colluding network nodes in the wireless network, availability of communication resources between the plurality of intermediate network nodes and the server and communication resources between the plurality of intermediate network nodes and the client device, and a privacy configuration of the client device (e.g., the level of privacy desired by the user). Depending on the configuration of the UE, some factors can be weighed more than others, and some factors may not be considered. For example, if the UEs have strict data privacy requirements, then factors affecting data privacy may be weighed more than factors affecting communication cost.

The data transmission scheme, which can include the encoding scheme, can be determined individually or jointly by the server, by a separate network entity (e.g., a standalone federator, such as federator 201′ of FIG. 2B) coupled to the server, by one or more intermediate network nodes (e.g., a base station, an access point, or another client device), or by one or more UEs that are sending data to the server. In some implementations, the determined data transmission scheme is conveyed to the various network components, e.g., the UEs, intermediate network nodes, and the server. A few examples of determining the data transmission scheme are given herein. As a first example, each UE decides the encoding scheme for transmitting its own private data without the influence of other UEs, the corresponding intermediate network node, or the server. As a second example, UEs in the same network or sub-network together decide what encoding scheme each UE uses. As a third example, each of the UEs does not make its own decision of the encoding scheme but follows the decision made by one or more of the intermediate network nodes, the server, or the network entity. As a fourth example, each UE decides how many and which one(s) of the intermediate network nodes to send encoded private data to. As a fifth example, each UE receives the decision from an intermediate network node, the server, or the network entity with regards to how many and which one(s) of the intermediate network nodes to send encoded private data to. As a sixth example, each intermediate network node decides whether to aggregate the received private data or forward the data to the server for aggregation. As a seventh example, the decision about aggregation is made by the server or the federator (if different) and indicated to each intermediate network node. The decision makers for the data transmission scheme can be the same for the entire wireless network and for all levels in the hierarchy, or can vary for different sub-networks and for different levels.

The data transmission scheme can be adaptively adjusted. For example, at a time during the data transmission, a UE can change the encoding scheme from one encryption algorithm to another encryption algorithm, and/or change the intermediate network nodes as a result of change of available network resources for sending the encoded data. Similarly, at a time during the data transmission, an intermediate network node can switch from aggregating the received data from not aggregating the received data as a result of change of communication cost between the UE and the intermediate network nodes and/or between the intermediate network nodes and the server. The decisions to make changes can be based on factors similar to those used to determine the initial schemes.

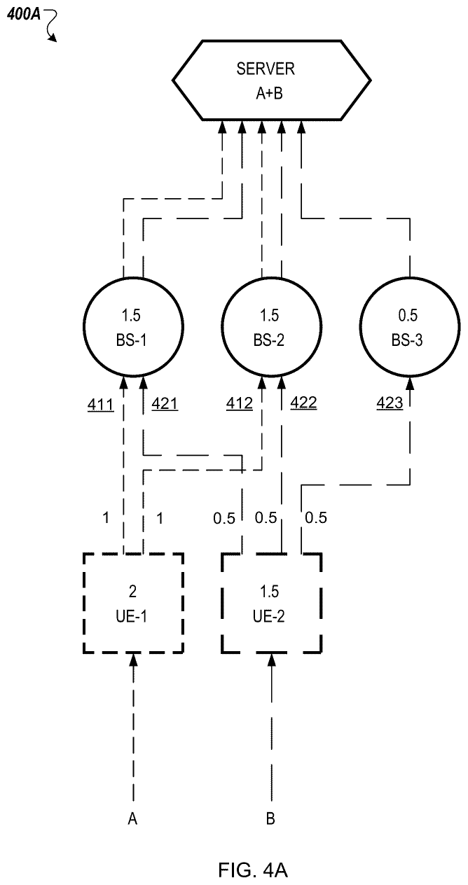

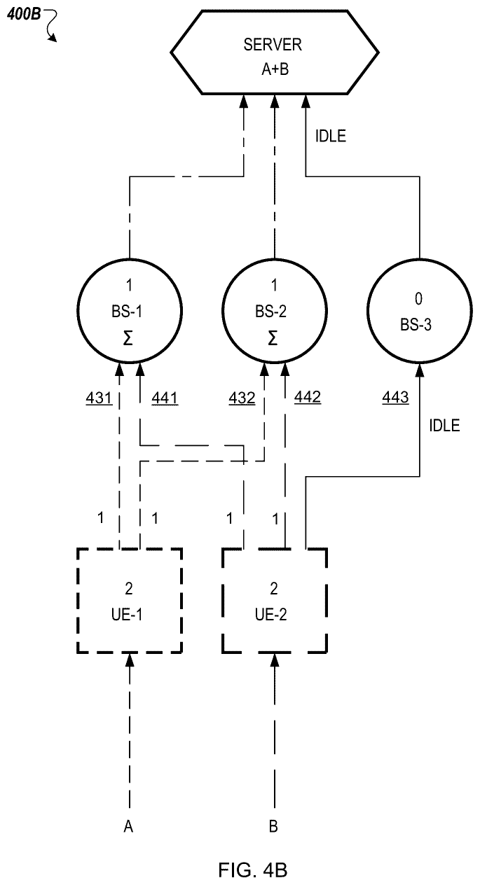

FIGS. 4A and 4B each illustrate an example data transmission scheme, 400A and 400B, respectively, for federated computing, according to some implementations. Data transmission schemes 400A and 400B involve a server, three base stations (BS-1 to BS-3), and two UEs (UE-1 and UE-2), which can be similar to the components of wireless network 300 that have the same labels. UE-1 and UE-2 obtain data A and B, respectively, for transmitting to the server. In the illustrated scenarios, any one of BS-1 to BS-3 may be a colluding node itself (T=1), but it does not find any other base station to collude with (which would be T≥2). This case of T=1 is described here for illustrative purposes only. Other implementations can have T>1 and require a larger number N of intermediate nodes. Further, it is assumed that D=0 in the illustrated scenarios although other scenarios can have large values of D. As discussed further in detail, data transmission scheme 400A of FIG. 4A can be adopted when it is desirable to minimize the data traffic between the UEs and the intermediate network nodes, while data transmission scheme 400B of FIG. 4B can be adopted when it is desirable to minimize the data traffic between the intermediate network nodes and the server.

In the scenario of FIG. 4A, it is assumed the data traffic has been normalized between data A and data B for one unit of cost. However, due to different encoding possibilities, data A incurs in total 2 units of cost for UE-1 to transmit, and data B incurs in total 1.5 units of cost for UE-2 to transmit. The cost can be measured as, e.g., the amount of communication resources utilized, power consumed, or data transmission fee charged by the network operator.

UE-1 has established communication links 411 and 412 with BS-1 and BS-2, respectively. Based on UE-1's data transmission scheme, UE-1 can transmit two instances (N₁=2 for UE-1) of its private encoded data to BS-1 and BS-2, respectively. Likewise, UE-2 has established communication links 421, 422, and 423 with BS-1, BS-2, and BS-3, respectively. Based on UE-2's data transmission scheme, UE-2 can transmit three instances (N₂=3 for UE-2) of its private encoded data to BS-1, BS-2, and BS-3, respectively. Using three instances instead of the minimum of just two to support privacy for T=1 allows UE-2 to leverage the additional communication link to use a more efficient encoding scheme thus bringing down the cost to 1.5 units of cost compared to 2 units as for UE-1.

The traffic per link (TpL) for links 411-412 and 421-423 can be represented as TpL=1/(Nᵢ-T-D)=1. In this formula, Nᵢ (i=1 or 2) denotes the number of BSs UE-1 or UE-2 has established communication links to. For UE-1, because N₁=2, TpL for UE-1 equals 1/(2−1−0)=1. For UE-2, because N₂=3, TpL for UE-2 equals 1/(3-1-0)=0.5. In other words, the cost on communication links 411 and 412 is 1 for each link, and the cost on communication links 421, 422, and 423 is 0.5 for each link. Viewed from the perspectives of the base stations, it takes 1+0.5=1.5 units of cost for BS-1 to receive the data from UE-1 and UE-2 via communication links 411 and 421, respectively. Similarly, it takes 1+0.5 units of cost for BS-2 to receive the data from UE-1 and UE-2 via communication links 412 and 422, and it takes 0.5 units of cost for BS-3 to receive the data from UE-2 via communication link 423.

Continuing with the scenario of FIG. 4A, each of BS-1 to BS-3 may or may not aggregate the encoded data received from UE-1 and UE-2. In some implementations where the encoding schemes for UE-1 and UE-2 are different, aggregation is possible only after the encoded data are decoded, which is not performed at BS-1 to BS-3 due to privacy concerns but performed at the server. Depending on the situation, this may not necessarily cause significant cost. For example, in a situation where there is ample capacity of communication between the BSs and the server, then data transmission scheme 400A can identify there is no need for optimization of the links of BS-1 to BS-3 and thus there is no incentive to aggregate the received data at the BSs. Consistent with this, it costs BS-1, BS-2, and BS-3 1.5 units, 1.5 units, and 0.5 units, respectively, to transmit their received data to the server. Note that although BS-1 to BS-3 cannot aggregate the encoded data of UE-1 and UE-2 due to different encoding schemes, the BSs can still aggregate encoded data from other UEs, if present, provided the other UEs encode their respective data using schemes that are compatible with others in the aggregation.

In the scenario of FIG. 4B, also assuming the data traffic has been normalized between data A and data B, but now UE-2 only utilizes the two links to BS-1 and BS-2 and lets the link to BS-3 idle. Now data A incurs in total 2 units of transmission cost on UE-1, and data B incurs in total 2 units of transmission cost on UE-2 (which means the encoding and efficiency is the same for both UEs). The cost can be measured as, e.g., the amount of communication resources utilized, power consumed, or data transmission fee charged by the network operator.

Similarly to the scenario of FIG. 4A, UE-1 has established communication links 431 and 432 with BS-1 and BS-2, respectively. Based on UE-1's data transmission scheme, UE-1 can transmit two instances (N₁=2) of its private encoded data to BS-1 and BS-2, respectively, same as UE-1's transmission paths in FIG. 4A. Likewise, UE-2 has established communication links 441, 442, and 443 with BS-1, BS-2, and BS-3, respectively. However, UE-2's data transmission scheme can specify that communication link 443 is to be left idle without data transmission. That is, although three links are available, UE-2's data transmission scheme specifies N₂ takes the value of 2 instead of 3. As such, UE-2 can transmit two instances of its private encoded data to BS-1 and BS-2, respectively, in spite of the presence of communication link 443.

Similar to the TpL calculation described earlier, because N₁=N₂=2 in the scenario of 400B, TpL for UE-1 equals 1/(2−1−0)=1 and TpL for UE-2 equals 1/(2−1−0)=1. Viewed from the perspectives of the base stations, it takes 1+1=2 units of cost for BS-1 to receive the data from UE-1 and UE-2 via communication links 431 and 441, respectively. Similarly, it takes 1+1 units of cost for BS-2 to receive the data from UE-1 and UE-2 via communication links 441 and 442. Also, since communication link 443 is left idle, no cost is incurred for BS-3 to receive data from UE-2. Although the traffic from UE-2 is higher in the scenario of FIG. 4B than in the scenario of FIG. 4A (2 is greater than 1.5), which can be less desirable, data transmission scheme 400B outperforms data transmission scheme 400A in another aspect, as explained below.

Each of BS-1 and BS-2 may now aggregate the encoded data received from UE-1 and UE-2 because the encoding schemes of UE-1 and UE-2 are compatible (e.g., the same). For example, in a situation where there is limited capacity of communication between the BSs and the server or where extra level of data privacy is desired, data transmission scheme 400B can specify that BS-1 and BS-2 each aggregate their received data (as indicated by the Σ symbol in FIG. 4B) and forward the aggregation results to the server. After aggregation, the encoded data instances from UE-1 and UE-2 become a single instance that costs 1 unit. Thus, it costs BS-1 and BS-2 each 1 unit to transmit their respective aggregation result to the server. Still, no cost is incurred for BS-3 to transmit data to the server. Compared with data transmission scheme 400A, data transmission scheme 400B reduces the traffic from the BSs to the server while still enabling the server to obtain the aggregation result A+B.

Data transmission schemes 400A and 400B illustrate the tradeoff of data traffic between the UE-BS communication links and the BS-server communication links. In other implementations, a wireless network can make similar tradeoffs by determining the data transmission scheme and the encoding scheme that satisfy the network environment, privacy requirement, and communication resources.

Further to the examples described with reference to FIGS. 4A and 4B, in some implementations, the ability of an intermediate network node to aggregate data from different client devices further depend on the encoding scheme adopted by the client devices. For example, aggregation may be enabled only when the client devices adopt the same encoding scheme, such as using the same encryption key or the same encryption algorithm or same number of random data added to the different instances with different weights. Various encoding schemes are available in implementations of this disclosure, including the IT privacy approach and the computational privacy approach described above, which can be jointly or separately applied.

In some encoding schemes, random information is added to (e.g., appended to, or interpolated to, or superimposed on) the private data. To generate multiple encoded instances of the same private data, a client device can add distinct random information to distinct portions of the same private data.

In some encoding schemes, a portion of the data is encrypted using an encryption algorithm. To generate multiple encoded instances of the same private data, a client device can use different encryption algorithms to encrypt different portions of the private data, or use the same encryption algorithms with different encryption keys to encrypt different portions of the private data.

As an example encryption algorithm, each client device encodes its private data aᵢ (i=1, 2, . . . ) based on a random padding key kᵢ to obtain an encoded instance xᵢ=aᵢ+kᵢ. After receiving instances xᵢ from all client devices, the server aggregates the received encoded data by computing a sum X=Sum (xᵢ). To preserve privacy, the client devices securely send their respective keys kᵢ to a trustee, which can be, e.g., an entity separate from the server or instantiated through a trustworthy private aggregation through one or more intermediate network nodes. The trustee calculates a sum K of the keys kᵢ as K=Sum (kᵢ) and provides K to the server for decoding. With the knowledge of X and K, the server can calculate the sum A of private data of aᵢ as A=X−K. This way, the server can use the sum of private data from client devices without learning the individual content of each instance of data transmitted by each client device. This way, federated computing can be carried out without breaching the privacy of each client device.

In some encoding schemes, the aforementioned addition of random information is combined with the encryption. For example, a first portion of the private data can be added with random information and a second portion of the private data can be encrypted, whereas the first portion and the second portion may or may not be the same and may or may not overlap.

For a wireless network with multiple sub-networks, the sub-networks can share the same data transmission scheme and encoding scheme, or can separately decide the schemes according to their own network environment. For example, in wireless network 200 of FIGS. 2A and 2B, the sub-network under AP 220 and the sub-network under AP 260 can adopt the same data transmission scheme and encoding scheme or can decide on their own schemes independently.

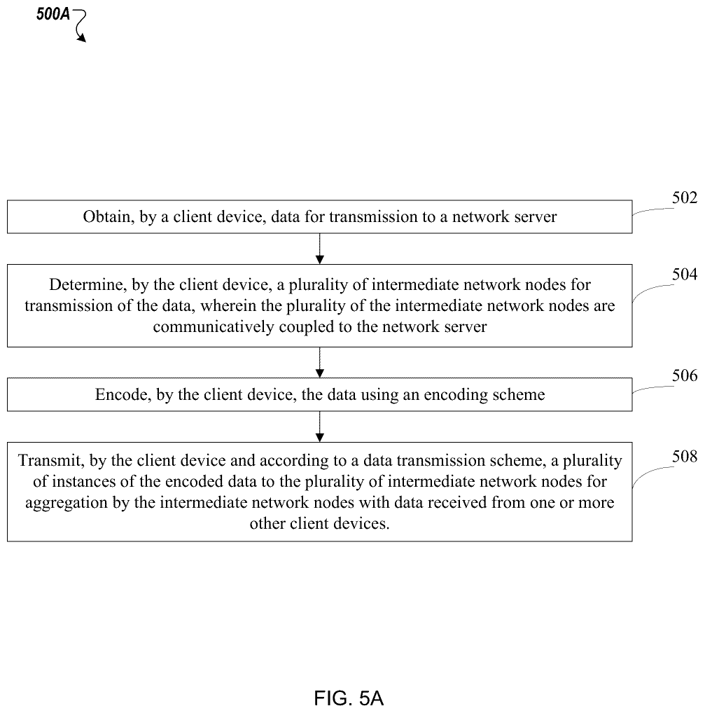

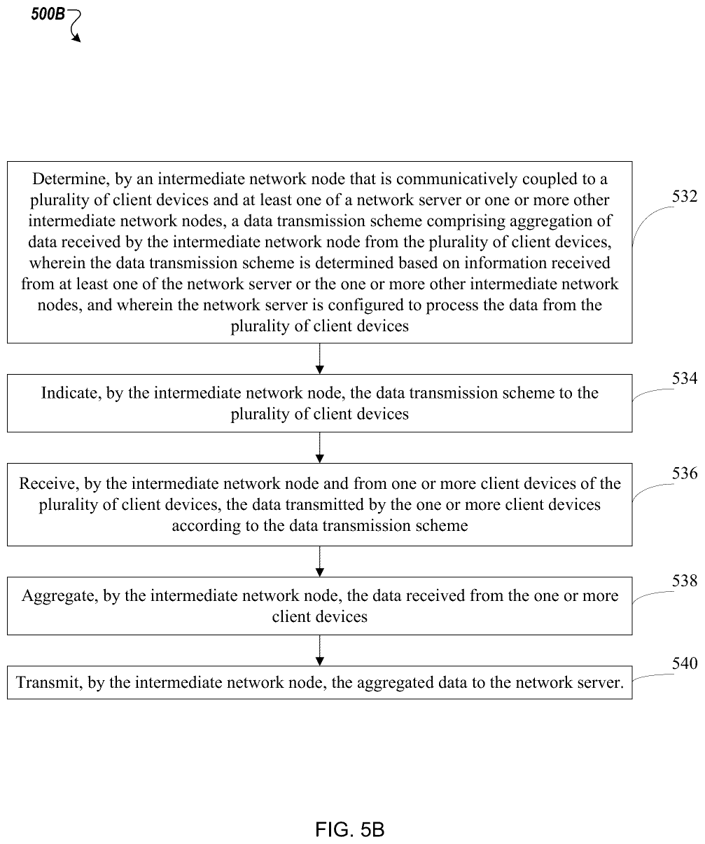

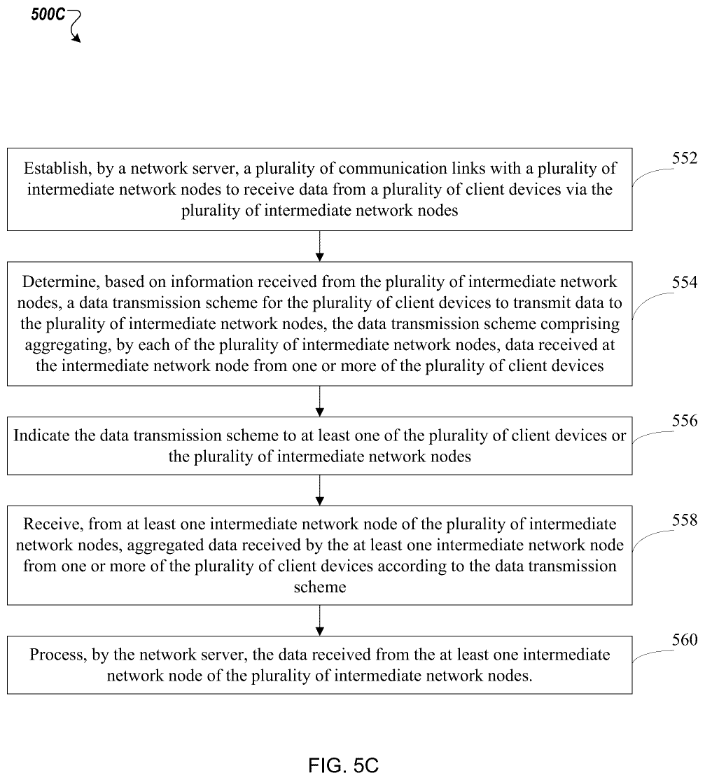

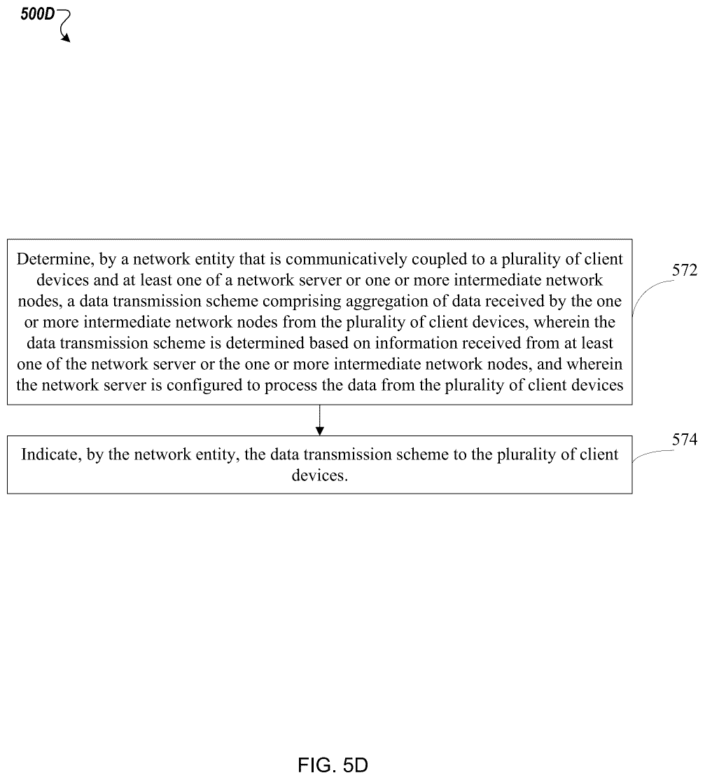

FIG. 5A illustrates a flowchart of an example method 500A for data aggregation in federated computing, according to some implementations. For clarity of presentation, the description that follows generally describes method 500A in the context of the other figures in this description. For example, method 500A can be performed by any of UEs 221, 222, 231, or 232 of FIG. 2A. It will be understood that method 500A can be performed, for example, by any suitable system, environment, software, hardware, or a combination of systems, environments, software, and hardware, as appropriate. In some implementations, various steps of method 500A can be run in parallel, in combination, in loops, or in any order.

At 502, method 500A involves obtaining, by a client device, data for transmission to a network server. The data can be private data that the network server uses for, e.g., training a machine learning model.

At 504, method 500A involves determining, by the client device, a plurality of intermediate network nodes for transmission of the data, wherein the plurality of the intermediate network nodes are communicatively coupled to the network server. The intermediate network nodes can be similar to the BSs illustrated in FIGS. 3, 4A, and 4B.

At 506, method 500A involves encoding, by the client device, the data using an encoding scheme. The encoding scheme can adopt the IT privacy approach or the computational privacy approach.

At 508, method 500A involves transmitting, by the client device and according to a data transmission scheme, a plurality of instances of the encoded data to the plurality of intermediate network nodes for aggregation by the intermediate network nodes with data received from one or more other client devices. The aggregation can take place at some of the intermediate network nodes or can take place at the network server.

FIG. 5B illustrates a flowchart of an example method 500B for data aggregation in federated computing, according to some implementations. For clarity of presentation, the description that follows generally describes method 500B in the context of the other figures in this description. For example, method 500B can be performed by any of AP 220 or BS 230 of FIG. 2A. It will be understood that method 500B can be performed, for example, by any suitable system, environment, software, hardware, or a combination of systems, environments, software, and hardware, as appropriate. In some implementations, various steps of method 500B can be run in parallel, in combination, in loops, or in any order.

At 532, method 500B involves determining, by an intermediate network node that is communicatively coupled to a plurality of client devices and at least one of a network server or one or more other intermediate network nodes, a data transmission scheme including aggregation of data received by the intermediate network node from the plurality of client devices. The data transmission scheme is determined based on information received from at least one of the network server or the one or more other intermediate network nodes. The network server is configured to process the data from the plurality of client devices.

At 534, method 500B involves indicating, by the intermediate network node, the data transmission scheme to the plurality of client devices.

At 536, method 500B involves receiving, by the intermediate network node and from one or more client devices of the plurality of client devices, the data transmitted by the one or more client devices according to the data transmission scheme.

At 538, method 500B involves aggregating, by the intermediate network node, the data received from the one or more client devices.

At 540, method 500B involves transmitting, by the intermediate network node, the aggregated data to the network server.

FIG. 5C illustrates a flowchart of an example method 500C for data aggregation in federated computing, according to some implementations. For clarity of presentation, the description that follows generally describes method 500C in the context of the other figures in this description. For example, method 500C can be performed by server 201 of FIG. 2B. It will be understood that method 500C can be performed, for example, by any suitable system, environment, software, hardware, or a combination of systems, environments, software, and hardware, as appropriate. In some implementations, various steps of method 500C can be run in parallel, in combination, in loops, or in any order.

At 552, method 500C involves establishing, by a network server, a plurality of communication links with a plurality of intermediate network nodes to receive data from a plurality of client devices via the plurality of intermediate network nodes. The intermediate network nodes can be similar to the BSs illustrated in FIGS. 3, 4A, and 4B. The client devices can be similar to the UEs illustrated in FIGS. 3, 4A, and 4B.

At 554, method 500C involves determining, based on information received from the plurality of intermediate network nodes, a data transmission scheme for the plurality of client devices to transmit data to the plurality of intermediate network nodes. The data transmission scheme includes aggregating, by each of the plurality of intermediate network nodes, data received at the intermediate network node from one or more of the plurality of client devices.

At 556, method 500C involves indicating the data transmission scheme to at least one of the plurality of client devices or the plurality of intermediate network nodes.

At 558, method 500C involves receiving, from at least one intermediate network node of the plurality of intermediate network nodes, aggregated data received by the at least one intermediate network node from one or more of the plurality of client devices according to the data transmission scheme.

At 560, method 500C involves processing, by the network server, the data received from the at least one intermediate network node of the plurality of intermediate network nodes. The processing can include, e.g., providing the data to a machine learning model for training.

FIG. 5D illustrates a flowchart of an example method 500D for data aggregation in federated computing, according to some implementations. For clarity of presentation, the description that follows generally describes method 500D in the context of the other figures in this description. Method 500D can be performed by a network entity, such as federator 201′ of FIG. 2B. It will be understood that method 500D can be performed, for example, by any suitable system, environment, software, hardware, or a combination of systems, environments, software, and hardware, as appropriate. In some implementations, various steps of method 500D can be run in parallel, in combination, in loops, or in any order.

At 572, method 500D involves determining, by a network entity that is communicatively coupled to a plurality of client devices and at least one of a network server or one or more intermediate network nodes, a data transmission scheme including aggregation of data received by the one or more intermediate network nodes from the plurality of client devices. The data transmission scheme is determined based on information received from at least one of the network server or the one or more intermediate network nodes. The network server is configured to process the data from the plurality of client devices.

At 574, method 500D involves indicating, by the network entity, the data transmission scheme to the plurality of client devices. The indication can be directly provided to the client devices, or can be indirectly provided to the client devices via one or more intermediate network nodes.

This disclosure provides techniques based on information theory to further enhance user privacy in federated computing. The below examples can apply to a hierarchical wireless network architecture, such that shown in FIG. 2C, in which n clients (e.g., UEs) are communicatively coupled to each other through base stations. The base stations either directly communicate with the federator or indirectly communicate with the federator via relay devices. Each client is communicatively coupled to multiple base stations.

In some implementations, additional user data protection can be provided by padding data with keys, with the keys being accessible by the federator. For example, data can be padded by adding randomly generated keys to the data. The addition of the keys can be done in finite field arithmetic within a finite field F_{q}, e.g., using modulo arithmetic to avoid overflows. If the sum is above a certain value q then q is subtracted to bring the result down again, where q is the size of the finite field. In order to case arithmetic q can be chosen to be a prime number of sufficient size. In this way it can be avoided, that the data after padding require more bandwidth (e.g., more bits) to transmit than allocated.

As the padding is done with random keys, the result appears to be random to an intruder and consequently does not reveal information on the original data. This is also true when adding up padded data from multiple contributors (e.g. a subset of the contributors, not necessarily all contributors), then this sum is the sum of the data of the contributors and the sum of their keys and as the latter are random, it does not reveal information on the data. Note that again modulo or finite field arithmetic can be used to avoid overflow, this also applies to all subsequent operations and will therefore not be highlighted any more. However, if an intruder is able to obtain the sum of padded data of a subset of contributors and the corresponding keys for the same subset of contributors, then the intruder can subtract the padding keys from the padded sum and gets the sum of the data. While this sum does not reveal the data of the individual contributors, it gives considerably more information about the subset of contributors than the corresponding sum over all contributors, in particular, if the subset only contains a few contributors, e.g., a handful of contributors. Therefore, it is desirable to avoid that data and corresponding keys of a subset of contributors can be inferred by an intruder or by a set of colluding nodes, that could infer it by exchanging and jointly using all the information they have got.

Some examples below describe how to aggregate the keys and the data, avoiding a matching pair of data and corresponding keys for any subset of the contributors.

In some implementations, to provide privacy against at most Z_{BS} base stations colluding with the federator and at most Z_{UE} UEs, keys and padded gradients (e.g., gradients+keys) are aggregated separately. This setting can be referred to as full collusion. In contrast to full collusion, partial collusion does not have the federator collude with the base stations, so at most Z_{UE} UEs may collude with either at most Z_{BS} base stations or the federator.

For example, each client i generates a key vector kᵢ randomly. Key vector kᵢ has the same dimension as the gradient vector gᵢ, which is private to client i. Each client pads (e.g., mixes) its private gradient vector with the random vector and uses secret sharing to distribute the padded gradient vector to nᵢ base stations, in order to enable protection against at most Z_{BS} base stations nᵢ must be at least (Z_{BS}+1). If nᵢ is larger than this minimum number (Z_{BS}+1), then, as shown below, the secret sharing can be enhanced which will reduce the overhead. Note that nᵢ may be (but does not have to be) different for different clients i.

To do the secret sharing, the gradient vector gᵢ and the random vector kᵢ can be each split into vᵢ=(nᵢ-Z_{BS}) parts, such as gᵢ=(gᵢ⁽¹⁾, gᵢ⁽²⁾, . . . gᵢ^{(vi)}) and kᵢ=(kᵢ⁽¹⁾, kᵢ⁽²⁾, . . . kᵢ^{(vi)}). The secret shares are generated by encoding the vector gᵢ+kᵢ into a polynomial of Equation 1 below:

$${f}_{i} ( x ) = {\sum }_{𝒿 ∈ [ {v}_{i} ]} {x}^{j - 1} ( {g}_{i}^{( j )} + {k}_{i}^{( j )} ) + {\sum }_{j ∈ [ {z}_{BS} ]} {x}^{{v}_{i} + j - 1} {r}_{i}^{( j )}$$

where [symbol] a random vector, independently and uniformly drawn from F_{q}, sometimes denoted as [symbol] , a suitably selected finite field of size q, for any j representing an index of a colluding base station.

Each base station u is assigned a distinct evaluation point αᵤ. Each client i then sends a secret share [symbol] (αᵤ) to base station u for all base stations in communication with client i (denoted as Uᵢ). To be able to decode, i.e., to obtain the vector gᵢ+kᵢ, the federator should receive Z_{BS}+vᵢ evaluations of the polynomial [symbol] (x). The base stations can forward the message [symbol] (αᵤ) to the federator, which can then interpolate the received polynomials and thus obtain a summation of (gᵢ+kᵢ) received from all n clients.

It can be mathematically shown that the result obtained by the federator is statistically independent of the individual gradients and of the sum of gradients Σ_{i∈[n]}gᵢ as the individual vectors kᵢ are independently and uniformly distributed over F_{q}^{d}. For stronger privacy guarantees, the federator can be allowed only to obtain the sum of all gradients and not the sum of subsets of the gradients. For example, only Σ_{i∈[n]}kᵢ can be revealed to the federator, which has access to some individual (gᵢ+kᵢ) results. By revealing only the sum of all kᵢ's to the federator, the federator cannot obtain any information about the sum of any proper subset of the clients' models gᵢ.

To support secret key aggregation, each client i sends a corresponding random key vector kᵢ to a base station u in communication with client i. The base station aggregates all received random key vectors from all clients in communication. In some cases, each base station u owns a partial aggregation of the random key vectors of connected clients. Starting from base station u=1, the partial aggregation is transmitted to next base station u=2, which adds its own partial aggregation to the received partial aggregation and forwards the sum to the next base station u=3, and so on. Hence, each base station obtains an aggregate of its own partial aggregation and all partial aggregations from base stations with a lower index. The last base station u=b forwards the final aggregate to the federator. For base stations not receiving random key vectors, these base stations do not participate in the secret key aggregation.

The secret key aggregation scheme described above assumes no straggler tolerance, which means no base stations or relay nodes drop out. However, the scheme can be extended provide straggler tolerance by carefully adding an additional amount of shares generated by the clients. Similarly, the secret key aggregation scheme can be seen as Reed-Solomon codes and, through error correction, can be extended to handle malicious base stations and relays that send corrupt computations.

The above secret key aggregation scheme was described in the context of partial collusion. To extend the scheme to the full collusion assumption, specific partial aggregations of the random vectors kᵢ have to be made private against any number Z_{BS} base stations. This can be made possible by a careful instance-dependent system design described later in this disclosure.

In some implementations, the communication cost from the base stations to the federator can be decreased by increasing the communication cost from some of the clients to the base stations. Clients can choose to construct their secret sharing only for a subset of the connected base stations to facilitate more partial aggregation opportunities at the base stations by thoroughly aligning their secret shares with a larger set of other clients.

Described next is an aggregation scheme that protects the client's privacy even with full collusion, where the federator can collude with any set of Z_{BS} base stations with Z_{UE}=0. According to this scheme, secret share construction for client i according to Equation 1 is modified to apply for only a subset Yᵢ of the base stations in Uᵢ. In addition, each client i secret shares the key vectors kᵢ to another subset Xᵢ of the base stations in Uᵢ. Xᵢ and Yᵢ may or may not overlap and may or may not be complement subsets to each other in Uᵢ. Let yᵢ:=|Yᵢ|-Z_{BS} and xᵢ: =|Xᵢ|-Z_{BS}, then each client i constructs two secret shares formed by the following polynomials of Equation 2:

$${g}_{i} ( x ) = {\sum }_{j ϵ [ {y}_{i} ]} {x}^{j - 1} ( {g}_{i}^{( j )} + {k}_{i}^{( j )} ) + {\sum }_{j ϵ [ {z}_{BS} ]} {x}^{{y}_{i} + j - 1} {r}_{i}^{( j )}$$

$${h}_{i} ( x ) = {\sum }_{j ϵ [ {x}_{i} ]} {x}^{j - 1} {k}_{i}^{( j )} + {\sum }_{j ϵ [ {z}_{BS} ]} {x}^{{x}_{i} + j - 1} {s}_{i}^{( j )}$$

where [symbol] and [symbol] are random vectors independently and uniformly drawn from F_{q}^{d/yi} and F_{q}^{d/xi}, respectively, for any j representing an index of a colluding base station. Here it is assumed that the dimension d of the gradient which is also the dimension of the key are divisible by both yᵢ and xᵢ, so that the gradient respectively the key vector can be split into yᵢ respectively xᵢ vectors of dimensions d/xᵢ respectively d/yᵢ, denoted as [symbol] respectively [symbol] . These vectors are represented within multi-dimensional finite fields with the appropriate dimensions i.e., F_{q}^{d/yi}, and F_{q}^{d/xi}, respectively. If the dimension happens not to be divisible, then the vectors can be enlarged with dummy entries to the next larger dimension that is suitably divisible.

Each client i then sends evaluations of [symbol] (x) at distinct evaluation point αᵤ to all base stations in Yᵢ and sends evaluations of [symbol] (x) at distinct evaluation point αᵤ′ to all base stations in Xᵢ. Let y:={Yᵢ}_{i∈[n]} be the distinct sets of base stations used for secretly sharing the padded gradients and x:={Xᵢ}_{i∈[n]} be the distinct sets of base stations used for sharing the keys. For every possible set of base stations Y∈y⊂2^{[b]}, let P^{Y} be the set of all clients that share the same set Yᵢ=Y. Similarly, for X∈X⊂2^{[b]}, let P^{X} be the set of all clients that share the same set Xᵢ=X. Each base station u∈Y that receives secret shares from clients i∈P^{Y} aggregates the received secret shares and sends the aggregations to the federator. Likewise, each base station u∈X that receives secret shares from clients i∈P^{X} aggregates the received secret shares and sends the aggregations to the federator. The federator then aggregates the received shares of padded gradients of clients {P^{Y}}_{Y∈y} and the received shares of padded gradients of clients {P^{X}}_{X∈x}. To guarantee privacy, the (unified) power sets of these two sets are required to only intersect in [symbol] , which the federator relies on to reconstruct the sum of the clients' gradients, according to Equation 3 below. Here [symbol] =[n] denotes the set of all n clients. This means that only for the set of all clients both the sum of the padded gradients and the sum of the keys can be determined and thus the sum of gradients can be computed. For any smaller set of clients this is not possible, keeping the sum of gradients for all sets but the total set (including the sets with a single contributor only) private.

$$\{ ⋃ T \vert T ∈ {2}^{{\{ {P}^{Y} \}}_{Y ∈ y}} \} ⋂ \{ ⋃ T \vert T ∈ {2}^{{\{ {P}^{X} \}}_{X ∈ x}} \} = 𝒩 .$$

To ensure privacy of each client even if with full collusion, two sets X and Y can be determined according to coding theories based on two generator matrices. A first matrix G₁ can be a |y|×n matrix of linear block code. Each row of G₁ represents a set of base stations in y and each column represents a client among the n clients. The (i,j)-th entry of G₁ is set to 1 if client i sends shares of its padded gradient vector to the set of base stations in y indexed by j (e.g., the j-th base station in set y), and is set to 0 otherwise. The code C1 generated by uG₁ spans the space defined by

$$\{ ⋃ T \vert T ∈ {2}^{{\{ {P}^{Y} \}}_{Y ∈ y}} \} .$$

By construction, the weight of each column in G₁ is exactly one.

Similarly, a second matrix G₂ can be an |x|×n matrix of linear block code. Each row of G₂ represents a set of base stations in x and each column represents a client among the n clients. The (i,j)-th entry of G₂ is set to 1 if client i sends shares of its key vector to the set of base stations in x indexed by j (e.g., the j-th base station in set x), and is set to 0 otherwise. The code C2 generated by uG₂ spans the space defined by {UT|T∈2^{(P}^{^{X}})_{X∈x}}. By construction, the weight of each column in G₂ is exactly one.

It can be shown that to protect privacy against any number of colluding parties when Z_{UE}>0, G₁ and G₂ can be constructed such that a Hamming distance between (i) any code C1 (which is a vector) in G₁ that is not all-one and not all-zero, and (ii) any code C2 (which is a also vector) in G₂ that is not all-one and not all-zero, is greater than Z_{UE}. In other words, even after removing any Z_{UE} columns from each of G₁ and G₂, the rows of the submatrix of G₁ (with the remaining columns after the removal) are linearly independent from the rows of the submatrix of G₂ (with the remaining columns after the removal) when excluding the all-one and all-zero rows.

Further, since the all-one vector is in the span of both generator matrices, this implies that rows of G₁ and G₂ have weights of at least 1+Z_{UE}. Further, because the weight of every column in G₁ and G₂ is exactly one, linear combinations of rows in G₁ and G₂ can only increase the weight. Hence, the minimum Hamming distance is the minimum weight among the rows. Accordingly, the minimum Hamming distance within each of G₁ and G₂ is at least 1+Z_{UE}.

When G₁ and G₂ are constructed to have the above properties and sets X and Y are chosen for the clients to send key vectors and padded gradient vectors, it is mathematically impossible for the colluders to recover any partial aggregation of plain gradients despite knowing all partial aggregations in addition to the keys and gradients of any Z_{UE} colluding clients.

The following example illustrates the above extension of the private aggregation scheme to full collusion and compares the communication costs of both schemes to the lower bound.

Consider a setting with n=6 clients and b=5 base stations, where one client is allowed to collude with two base stations and the federator, i.e., Z_{UE}=1 and Z_{BS}=2. The clients have the following connectivity sets to denote which of the 5 base stations each client communicates with:

$${𝒰}_{1} = {𝒰}_{2} = \{ 1 , 2 , 3 , 5 \} ,$$

$${𝒰}_{3} = \{ 1 , 2 , 3 , 4 , 5 \} ,$$

$${𝒰}_{4} = \{ 2 , 3 , 4 , 5 \} ,$$

$${𝒰}_{5} = \{ 1 , 2 , 4 , 5 \} ,$$

$${𝒰}_{6} = \{ 1 , 2 , 5 \} .$$

The sets Yⱼ and Xⱼ in this example are chosen to be Y₁={1,3,5}, Y₂{2,3,4,5}, Y₃={1,2,5}, X₁={1,2,3,5}, X₂={2,4,5} and X₃={1,2,5}. In addition, the following two generator matrices G₁ and G₂ are constructed such that the minimum Hamming distance between any two non-zero non-one vectors from matrices G₁ and G₂ is at least 1+Z_{UE}=2. The matrices G₁ and G₂ can read as

$${G}_{1} = ( \begin{matrix}1 & 1 & 0 & 0 & 0 & 0 \\ 0 & 0 & 1 & 1 & 0 & 0 \\ 0 & 0 & 0 & 0 & 1 & 1\end{matrix} ) ,$$

$${G}_{2} = ( \begin{matrix}0 & 1 & 1 & 0 & 0 & 0 \\ 0 & 0 & 0 & 1 & 1 & 0 \\ 1 & 0 & 0 & 0 & 0 & 1\end{matrix} )$$

The construction in this example can attain the privacy guarantee even in case of full collusion. Under full collusion, the communication cost of can be computed as 48d. Under partial collusion, the communication cost of can be computed as 23.33d as compared to the lower bound, which is C_{LB}=15.67d.

The above approach of secure aggregation based on determining sets Y and X and constructing matrices G₁ and G₂ can apply to multi-level hierarchies, where one or more layers of relay nodes sit between the base stations (e.g., level 2 in FIG. 2C) and the federator (e.g., level 1 in FIG. 2C). In general, each base station is connected to multiple relay nodes. If up to Z_{R} relay nodes collude, each base station is communicatively coupled to at least Z_{R}+1 relay nodes. Similarly, if on a hierarchy level i up to Z_{R} nodes collude, each node from the previous level i−1 is communicatively coupled to at least Z_{R}+1 nodes from hierarchy level i.

In some implementations, base stations or relay nodes at one or more levels can encode the received data using the same encoding scheme as that used by the clients.

If entities on a hierarchy level higher than the clients have computed their own gradients, they can piggy-back these results on top of the data they forward. This is done by encoding them into a properly aligned secret sharing, whose shares are distributed to fellow entities on the same or the next level of the hierarchy. Then the aligned shares can be added up, which helps reduce the overall communication effort, as further discussed below.

The above approach can similarly apply to scenarios where colluders are located in different levels of a hierarchy. When each level of hierarchy, denoted by i, has up to a specific amount of colluders, Zᵢ colluders, that can all share private client data with each other across hierarchical boundaries, the secret sharing needs to have resilience against all colluders from all levels.

To this end, the clients construct secret shares of padded gradients and keys that can be aggregated on different levels. Aggregations from former levels are forwarded to later levels. New shares or aggregations thereof can be piggy-backed on top of such incoming aggregations. This can reduce the communication cost between later levels of the hierarchy compared with former ones and at the same time facilitates more aggregation opportunities that in turn case the construction of the matrices G₁ and G₂ with properties to fulfill the privacy guarantees. When such a construction is impossible, partial aggregations of gradients may be leaked to the federator. The leaked data could be the gradients of single clients in the worst case.

When there is a common set of entities on one level that receive shares from the same clients (with aligned evaluation points), those entities sum the shares of those clients and forward the result to entities on the next level. The forwarding has to be done in a way to match the guarantees on matrices G₁ and G₂.

In some implementations, a subset of the entities in some levels of the hierarchy are trusted to the extent of not colluding with others to compromise privacy. If base stations are trusted, clients connected to them can directly send them their plain gradients. Afterwards, such a base station forwards the plain gradient to a trusted entity of the succeeding level. When there does not exist such a trusted entity, the base station can construct a secret sharing and relay the shares through the later levels in the hierarchy in a privacy preserving manner, as described above.

In some implementations where some clients are trusted, the construction of G₁ and G₂ can be less constrained. For example, the distance requirement for aggregations that have shares from trusted clients can be reduced by the number of trusted clients.

The communication architecture according to some implementations can be further optimized by, e.g., insertion of proper intermediate aggregators and using specifically selected communication links. Instead of using one privacy preserving encoding across the entire aggregation tree, this can be done by re-encoding to proper schemes on different levels. For example, instead of decoding the clear data (to protect privacy), some implementations perform transcoding to data always protected. Further, error correction can be done on the way to mitigate malicious errors.

In certain situations, the secret sharing parameters are adapted from one level of hierarchy to another to ensure privacy (e.g., if on the subgraph connected to a client the privacy parameter is higher in a later level of hierarchy than the number of nodes in a previous one). In others there might be solutions with less communication. Using multiparty computation, the parameters of the secret sharing can be adapted from one level of hierarchy to the next level.

A communication system according to the above-described architecture may include a coordinating entity, which may coincide with another node in the system such as the federator, a base station, a relay node or a client. The coordinator coordinates the entire process. All nodes (clients, base stations, relays) communicate their connectivity to the coordinator through any available connection in the beginning of the scheme and upon any change. All nodes forward the other nodes' connectivity information in the same way as their own. The coordinator centrally decides for each node to which nodes it shall send its gradients, keys and (partial) aggregates (as applicable). Additionally, the coordinator decides which evaluation point is to be used for each transmission and which data is to be aggregated. It then communicates to the other nodes the information relevant to them through the same way the nodes sent their connectivity information. Again, nodes forward data to other nodes.

Whenever nodes drop out of the system or join the system, the coordinator decides again and communicates the new decisions to the nodes. Among all privacy preserving options, the coordinator selects one with low communication cost. Provided with sufficient computing power and for small systems, the coordinator can find the minimizing solution, e.g., through exhaustive search. Alternatively, the coordinator may use heuristics to decide on a solution with sufficiently low communication cost. Data communicated on different links might have different communication cost. Alternatively, the functionality of the coordinator can be split into multiple nodes, in particular to distribute the compute load or to enable to do partial processing on part of the information in a hierarchical fashion, which may reduce latency or compute and communication burden on these nodes.

In some implementations, malicious entities exist in the architecture and need to be accounted. The extension to private aggregation over multiple levels of hierarchy to account for corrupt computations is straightforward from the application of error correction in Reed-Solomon codes. That is, when at most a certain number of m received shares are expected to be corrupted upon reception by the federator, the correct gradients can be recovered through having an additional number of 2m received shares. Such corruptions could happen at any level of the hierarchy.

If m corruptions happen at multiple levels of the hierarchy, 2m shares are not sufficient in every case to reconstruct the gradients. In such cases, the decoding of the shares has to be done in place by means of multi-party computation (MPC) between the levels. Such an error-correction step can be incorporated in potential transcoding to facilitate resilience against a larger number of corruptions happening at each level.

This is a novel application of error-correction in Reed-Solomon codes for the setting of secure aggregation over multiple hierarchies, which can be combined with the previously introduced concepts.

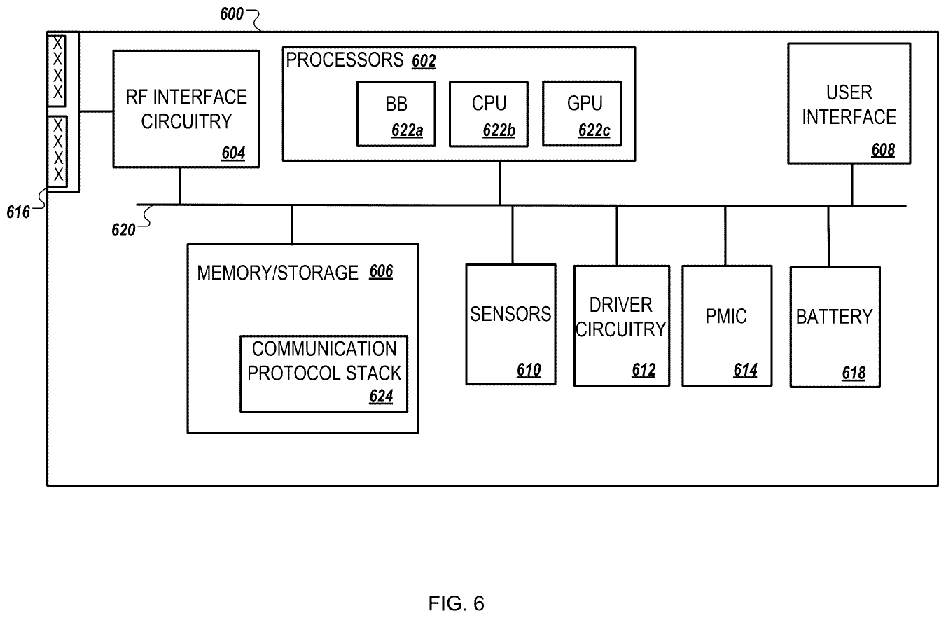

FIG. 6 illustrates an example UE 600, according to some implementations. The UE 600 may be similar to and substantially interchangeable with UE 102 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (Ics), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 includes any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616. In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

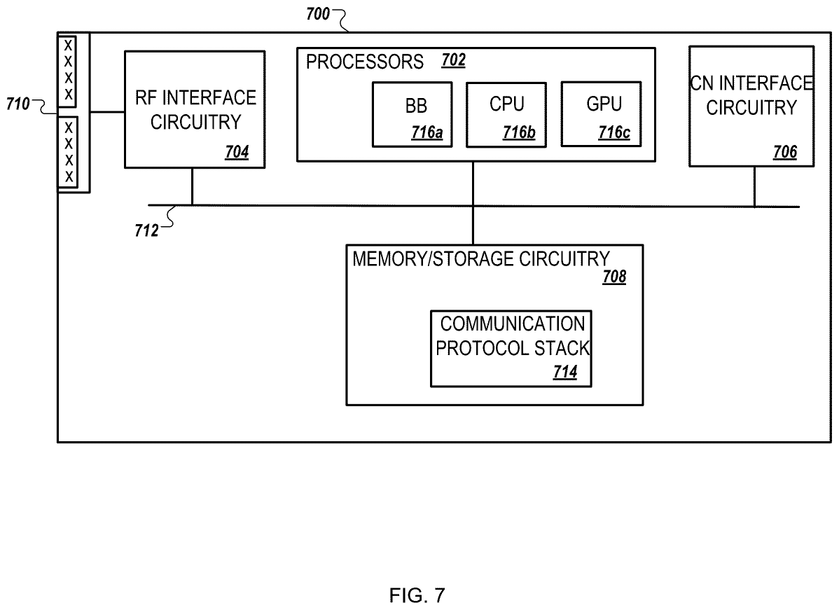

FIG. 7 illustrates an example access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, CPU 716B, and GPU 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary implementations are provided.

Example 1 includes a method performed by a client device. The method includes obtaining, by a client device, data for transmission to a network server. The method includes determining, by the client device, a plurality of intermediate network nodes for transmission of the data, wherein the plurality of the intermediate network nodes are communicatively coupled to the network server. The method includes encoding, by the client device, the data using an encoding scheme. The method includes transmitting, by the client device and according to a data transmission scheme, a plurality of instances of the encoded data to the plurality of intermediate network nodes for aggregation by the intermediate network nodes with data received from one or more other client devices.

Example 2 includes the method of example 1, further including receiving an indication of the data transmission scheme from at least one of: one or more intermediate network nodes of the plurality of intermediate network nodes, a network entity, or the network server.

Example 3 includes the method of example 1, further including determining the data transmission scheme based on at least one of: an amount of the data, a power for transmitting the data, a colluding factor that indicates a maximum number of colluding network nodes, a dropout factor that indicates a maximum number of dropout instances of the encoded data, communication resources between the plurality of intermediate network nodes and the server, communication resources between the plurality of intermediate network nodes and the client device, or a privacy configuration of the client device.

Example 4 includes the method of example 3, wherein determining the data transmission scheme includes calculating a traffic-per-link value based on the colluding factor and a number of the plurality of intermediate network nodes.

Example 5 includes the method of example 3, wherein the colluding factor is less than a total number of the plurality of intermediate network nodes.

Example 6 includes the method of example 3, wherein the plurality of instances include one or more redundant instances determined according to the dropout factor.

Example 7 includes the method of example 1, wherein encoding the data using the encoding scheme includes at least one of: adding random information to the data, or encrypting the data using an encryption algorithm.

Example 8 includes the method of example 7, wherein adding the random information to the data includes adding the random information to a portion of the.

Example 9 includes the method of example 8, wherein adding the random information to the data includes adding first random information to a first portion of the data, and adding second random information to a second portion of the data, wherein the first random information is distinct from the second random information, and the first portion is distinct from the second portion.

Example 10 includes the method of example 7, wherein encoding the data using the encoding scheme includes: adding random information to a first portion of the data; and encrypting a second portion of the data using the encryption algorithm.

Example 11 includes the method of example 10, wherein the first portion is distinct from the second portion.

Example 12 includes the method of example 10, wherein the first portion is same as the second portion.

Example 13 includes the method of example 1, wherein the plurality of intermediate network nodes includes at least one of: a base station, an access point, or another client device.

Example 14 includes the method of example 1, further including: adaptively adjusting at least one of the data transmission scheme or the encoding scheme.

Example 15 includes the method of example 14, wherein, at a first time during the transmission of the data, the encoding scheme is a first encoding scheme and the plurality of intermediate network nodes is a first plurality of intermediate network nodes, and wherein adaptively adjusting at least one of the data transmission scheme or the encoding scheme includes at least one of: at a second time during the transmission of the data, encoding the data using a second encoding scheme that is different from the first encoding scheme, or at the second time during the transmission of the data, transmitting the data to a second plurality of intermediate network nodes that is different from the first plurality of intermediate network nodes.

Example 16 includes the method of example 15, wherein the first encoding scheme includes a randomization-based scheme and the second encoding scheme includes an encryption-based scheme, or wherein the second encoding scheme includes a randomization-based scheme and the first encoding scheme includes an encryption-based scheme.

Example 17 includes the method of example 1, wherein the data includes information for training a machine learning model by the network server.

Example 18 includes the method of example 17, wherein the machine learning model is configured to conduct a plurality of stochastic gradient descent (SGD) iterations, and wherein the data includes gradient information used in the SGD iterations.

Example 19 includes the method of example 1, wherein the encoding scheme is configured to prevent an intermediate network node from reading a portion of the data, and wherein the data transmission scheme is configured to prevent the network server from identifying the client device based on the data.

Example 20 includes a method performed by an intermediate network node. The method includes determining, by an intermediate network node that is communicatively coupled to a plurality of client devices and at least one of a network server or one or more other intermediate network nodes, a data transmission scheme including aggregation of data received by the intermediate network node from the plurality of client devices, wherein the data transmission scheme is determined based on information received from at least one of the network server or the one or more other intermediate network nodes, and wherein the network server is configured to process the data from the plurality of client devices; indicating, by the intermediate network node, the data transmission scheme to the plurality of client devices; receiving, by the intermediate network node and from one or more client devices of the plurality of client devices, the data transmitted by the one or more client devices according to the data transmission scheme; aggregating, by the intermediate network node, the data received from the one or more client devices; and transmitting, by the intermediate network node, the aggregated data to the network server.

Example 21 includes the method of example 20, wherein the information includes at least one of: an amount of the data, a power for transmitting the data, a colluding factor that indicates a maximum number of colluding intermediate network nodes, a dropout factor that indicates a maximum number of dropout instances of the encoded data, communication resources between the intermediate network node and the server, communication resources between the intermediate network node and the client device, or a privacy configuration of the client device.

Example 22 includes the method of example 21, wherein determining the data transmission scheme includes calculating a traffic-per-link value based on the colluding factor and a total number of intermediate network nodes.

Example 23 includes the method of example 21, wherein the colluding factor is less than a total number of intermediate network nodes.

Example 24 includes the method of example 21, wherein the dropout factor indicates a number of redundant instances transmitted by the one or more client devices.

Example 25 includes the method of example 20, wherein the intermediate network node includes at least one of: a base station, an access point, or a client device.

Example 26 includes the method of example 20, further including adaptively adjusting the data transmission scheme.

Example 27 includes the method of example 26, wherein, at a first time during the transmission of the data, the data transmission scheme is a first data transmission scheme, and wherein adaptively adjusting the data transmission scheme includes: at a second time during the transmission of the data, indicating, to the plurality of client devices, a second data transmission scheme that is different from the first data transmission scheme.

Example 28 includes the method of example 20, wherein the data includes information for training a machine learning model by the network server.

Example 29 includes the method of example 28, wherein the machine learning model is configured to conduct a plurality of stochastic gradient descent (SGD) iterations, and wherein the data includes gradient information used in the SGD iterations.

Example 30 includes the method of example 20, wherein the data is private to the client device, wherein the data transmission scheme includes an encoding scheme, wherein the encoding scheme is configured to prevent the intermediate network node from reading a portion of the data, and wherein the data transmission scheme is configured to prevent the network server from identifying the client device based on the data.

Example 31 includes a method performed by a network server. The method includes establishing, by a network server, a plurality of communication links with a plurality of intermediate network nodes to receive data from a plurality of client devices via the plurality of intermediate network nodes; determining, based on information received from the plurality of intermediate network nodes, a data transmission scheme for the plurality of client devices to transmit data to the plurality of intermediate network nodes, the data transmission scheme including aggregating, by each of the plurality of intermediate network nodes, data received at the intermediate network node from one or more of the plurality of client devices; indicating the data transmission scheme to at least one of the plurality of client devices or the plurality of intermediate network nodes; receiving, from at least one intermediate network node of the plurality of intermediate network nodes, aggregated data received by the at least one intermediate network node from one or more of the plurality of client devices according to the data transmission scheme; and processing, by the network server, the data received from the at least one intermediate network node of the plurality of intermediate network nodes.

Example 32 includes the method of example 31, wherein the information includes at least one of: an amount of the data, a power for transmitting the data, a colluding factor that indicates a maximum number of colluding intermediate network nodes, a dropout factor that indicates a maximum number of dropout instances of the encoded data, communication resources between the plurality of intermediate network nodes and the server, communication resources between the plurality of intermediate network nodes and the client device, or a privacy configuration of the client device.

Example 33 includes the method of example 32, wherein determining the data transmission scheme includes calculating a traffic-per-link value based on the colluding factor and a number of the plurality of intermediate network nodes.

Example 34 includes the method of example 32, wherein the colluding factor is less than a total number of the plurality of intermediate network nodes.

Example 35 includes the method of example 31, wherein the intermediate network node includes at least one of: a base station, an access point, or a client device.

Example 36 includes the method of example 28, further including: adaptively adjusting the data transmission scheme.

Example 37 includes the method of example 36, wherein, at a first time during the transmission of the data, the data transmission scheme is a first data transmission scheme, and wherein adaptively adjusting the data transmission scheme includes: at a second time during the transmission of the data, indicating, to the plurality of client devices, a second data transmission scheme that is different from the first data transmission scheme.

Example 38 includes the method example 31, wherein processing the data includes training a machine learning model using the data, wherein the machine learning model is configured to conduct a plurality of stochastic gradient descent (SGD) iterations, and wherein the data includes gradient information used in the SGD iterations.

Example 39 includes a method performed by a network entity that is communicatively coupled to a plurality of client devices and at least one of a network server or one or more intermediate network nodes. The method includes determining a data transmission scheme including aggregation of data received by the one or more intermediate network nodes from the plurality of client devices, wherein the data transmission scheme is determined based on information received from at least one of the network server or the one or more intermediate network nodes, and wherein the network server is configured to process the data from the plurality of client devices; and indicating, by the network entity, the data transmission scheme to the plurality of client devices.

Example 40 may include one or more non-transitory computer-readable media including instructions to cause an electronic device, upon execution of the instructions by one or more processors of the electronic device, to perform one or more elements of a method described in or related to any of examples 1-39.

Example 41 may include one or more processors configured to execute instructions that cause the one or more processors to perform the method of any of examples 1-39

Example 42 may include an apparatus including one or more processors configured to perform the method of any of examples 1-39.

Example 43 may include an apparatus including logic, modules, or circuitry to perform one or more elements of a method described in or related to any of examples 1-39, or any other method or process described herein.

Example 44 may include a method, technique, or process as described in or related to any of examples 1-39, or portions or parts thereof.

Example 45 may include an apparatus including: one or more processors and one or more computer-readable media including instructions that, when executed by the one or more processors, cause the one or more processors to perform the method, techniques, or process as described in or related to any of examples 1-39, or portions thereof.

Example 46 may include a signal as described in or related to any of examples 1-39, or portions or parts thereof.

Example 47 may include a datagram, information element, packet, frame, segment, PDU, or message as described in or related to any of examples 1-39, or portions or parts thereof, or otherwise described in the present disclosure.

Example 48 may include a signal encoded with data as described in or related to any of examples 1-39, or portions or parts thereof, or otherwise described in the present disclosure.

Example 49 may include a signal encoded with a datagram, IE, packet, frame, segment, PDU, or message as described in or related to any of examples 1-39, or portions or parts thereof, or otherwise described in the present disclosure.

Example 50 may include an electromagnetic signal carrying computer-readable instructions, wherein execution of the computer-readable instructions by one or more processors is to cause the one or more processors to perform the method, techniques, or process as described in or related to any of examples 1-39, or portions thereof.

Example 51 may include a computer program including instructions, wherein execution of the program by a processing element is to cause the processing element to carry out the method, techniques, or process as described in or related to any of examples 1-39, or portions thereof. The operations or actions performed by the instructions executed by the processing element can include the methods of any one of examples 1-39.

Example 52 may include a signal in a wireless network as shown and described herein.

Example 53 may include a method of communicating in a wireless network as shown and described herein.

Example 54 may include a system for providing wireless communication as shown and described herein. The operations or actions performed by the system can include the methods of any one of examples 1-39.

Example 55 may include a device for providing wireless communication as shown and described herein. The operations or actions performed by the device can include the methods of any one of examples 1-39.

Example 56 may include the method of example 1, further comprising: generating a key vector corresponding to the client device; generating a gradient vector corresponding to the client device; padding the gradient vector with the key vector to generate a padded gradient vector; generating a plurality of randomized padded gradient vectors corresponding to a first subset of the plurality of intermediate network nodes; and transmitting each of the plurality of randomized padded gradient vectors to a different intermediate network node of the first subset.

Example 57 may include the method of example 56, further comprising: generating a plurality of randomized key vectors corresponding to a second subset of the plurality of intermediate network nodes; transmitting each of the plurality of randomized key vectors to a different intermediate network node of the second subset, wherein numbers of intermediate network nodes in each of the first subset and the second subset is greater than Z_{BS}, where Z_{BS} represents a maximum number of colluding intermediate network nodes.

Example 58 may include the method of example 57, further comprising: determining a first generator matrix corresponding to the first subset; and determining a second generator matrix corresponding to the second subset; wherein a minimum Hamming distance of each of the first generator matrix and the second generator matrix is greater than Z_{UE}, and wherein a Hamming distance between (i) any vector in the first generator matrix that is not all-one and not all-zero, and (ii) any vector in the second generator matrix that is not all-one and not all-zero, is greater than Z_{UE}, where Z_{UE} represents a maximum number of client devices that collude with the colluding intermediate network nodes.

Example 59 may include the method of example 56, further comprising determining the first subset and the second subset of intermediate network nodes such that the colluding intermediate network nodes are mathematically unable to determine the padded gradient vector based on information about the key vector and the encoded data.

Example 60 may include the method of example 1, wherein the plurality of intermediate network nodes have multiple levels of hierarchy, and wherein one or more intermediate network nodes at at least one level of the hierarchy are configured to encode received data using the encoding scheme.

The previously-described examples 1-60 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The operations or actions performed either by the system or by the instructions executed by data processing apparatus can include the methods of any one of examples 1-60.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

What is claimed is:

1. A method comprising:
obtaining, by a client device, data for transmission to a network server;
determining, by the client device, a plurality of intermediate network nodes for transmission of the data, wherein the plurality of the intermediate network nodes are communicatively coupled to the network server;
encoding, by the client device, the data using an encoding scheme; and
transmitting, by the client device and according to a data transmission scheme, a plurality of instances of the encoded data to the plurality of intermediate network nodes for aggregation by the intermediate network nodes with data received from one or more other client devices.

2. The method of claim 1, further comprising determining the data transmission scheme based on at least one of:
an amount of the data,
a power for transmitting the data,
a colluding factor that indicates a maximum number of colluding intermediate network nodes,
a dropout factor that indicates a maximum number of dropout instances of the encoded data,
communication resources between the plurality of intermediate network nodes and the server,
communication resources between the plurality of intermediate network nodes and the client device, or
a privacy configuration of the client device.

3. The method of claim 2, wherein determining the data transmission scheme comprises calculating a traffic-per-link value based on the colluding factor and a number of the plurality of intermediate network nodes.

4. The method of claim 2, wherein the colluding factor is less than a total number of the plurality of intermediate network nodes.

5. The method of claim 1, wherein encoding the data using the encoding scheme comprises at least one of:
adding random information to the data, or
encrypting the data using an encryption algorithm.

6. The method of claim 5, wherein adding the random information to the data comprises adding the random information to a portion of the data.

7. The method of claim 6, wherein adding the random information to the data comprises adding first random information to a first portion of the data, and adding second random information to a second portion of the data, wherein the first random information is distinct from the second random information, and the first portion is distinct from the second portion.

8. The method of claim 5, wherein encoding the data using the encoding scheme comprises:
adding random information to a first portion of the data; and
encrypting a second portion of the data using the encryption algorithm.

9. The method of claim 1, wherein the plurality of intermediate network nodes comprise at least one of: a base station, an access point, or another client device.

10. The method of claim 1, further comprising: adaptively adjusting at least one of the data transmission scheme or the encoding scheme.

11. The method of claim 10, wherein, at a first time during the transmission of the data, the encoding scheme is a first encoding scheme and the plurality of intermediate network nodes is a first plurality of intermediate network nodes, and wherein adaptively adjusting at least one of the data transmission scheme or the encoding scheme comprises at least one of:
at a second time during the transmission of the data, encoding the data using a second encoding scheme that is different from the first encoding scheme, or
at the second time during the transmission of the data, transmitting the data to a second plurality of intermediate network nodes that is different from the first plurality of intermediate network nodes.

12. The method of claim 1, wherein the data comprises information for training a machine learning model by the network server.

13. The method of claim 12, wherein the machine learning model is configured to conduct a plurality of stochastic gradient descent (SGD) iterations, and wherein the data comprises gradient information used in the SGD iterations.

14. The method of claim 1, further comprising:
generating a key vector corresponding to the client device;
generating a gradient vector corresponding to the client device;
padding the gradient vector with the key vector to generate a padded gradient vector;
generating a plurality of randomized padded gradient vectors corresponding to a first subset of the plurality of intermediate network nodes; and
transmitting each of the plurality of randomized padded gradient vectors to a different intermediate network node of the first subset.

15. The method of claim 14, further comprising:
generating a plurality of randomized key vectors corresponding to a second subset of the plurality of intermediate network nodes, the second subset being different from the first subset;
transmitting each of the plurality of randomized key vectors to a different intermediate network node of the second subset,
wherein numbers of intermediate network nodes in each of the first subset and the second subset is greater than Z_{BS}, where Z_{BS} represents a maximum number of colluding intermediate network nodes.

16. The method of claim 15, further comprising:
determining a first generator matrix corresponding to the first subset; and
determining a second generator matrix corresponding to the second subset,
wherein a minimum Hamming distance of each of the first generator matrix and the second generator matrix is greater than Z_{UE}, and
wherein a Hamming distance between (i) any vector in the first generator matrix that is not all-one and not all-zero, and (ii) any vector in the second generator matrix that is not all-one and not all-zero, is greater than Z_{UE}, where Z_{UE} represents a maximum number of client devices that collude with the colluding intermediate network nodes.

17. The method of claim 14, further comprising determining the first subset and the second subset of intermediate network nodes such that the colluding intermediate network nodes are mathematically unable to determine the padded gradient vector based on information about the key vector and the encoded data.

18. The method of claim 1, wherein the plurality of intermediate network nodes have multiple levels of hierarchy, and wherein one or more intermediate network nodes at at least one level of the hierarchy are configured to encode received data using the encoding scheme.

19. A method comprising:
determining, by an intermediate network node that is communicatively coupled to a plurality of client devices and at least one of a network server or one or more other intermediate network nodes, a data transmission scheme comprising aggregation of data received by the intermediate network node from the plurality of client devices, wherein the data transmission scheme is determined based on information received from at least one of the network server or the one or more other intermediate network nodes, and wherein the network server is configured to process the data from the plurality of client devices;
indicating, by the intermediate network node, the data transmission scheme to the plurality of client devices;
receiving, by the intermediate network node and from one or more client devices of the plurality of client devices, the data transmitted by the one or more client devices according to the data transmission scheme;
aggregating, by the intermediate network node, the data received from the one or more client devices; and
transmitting, by the intermediate network node, the aggregated data to the network server.

20. A method comprising:
establishing, by a network server, a plurality of communication links with a plurality of intermediate network nodes to receive data from a plurality of client devices via the plurality of intermediate network nodes;
determining, based on information received from the plurality of intermediate network nodes, a data transmission scheme for the plurality of client devices to transmit data to the plurality of intermediate network nodes, the data transmission scheme comprising aggregating, by each of the plurality of intermediate network nodes, data received at the intermediate network node from one or more of the plurality of client devices;
indicating the data transmission scheme to at least one of the plurality of client devices or the plurality of intermediate network nodes;
receiving, from at least one intermediate network node of the plurality of intermediate network nodes, aggregated data received by the at least one intermediate network node from one or more of the plurality of client devices according to the data transmission scheme; and
processing, by the network server, the data received from the at least one intermediate network node of the plurality of intermediate network nodes.
